(19) United States
(12) Patent Application Publication
(10) Pub. No.: US 2007/0257897 A1
(43) Pub. Date: Nov. 8, 2007

(54) DRIVER APPARATUS FOR OFFSET CANCEL AND AMPLIFIER APPARATUS FOR OFFSET CANCEL THEREOF

(75) Inventor: Yue-Hung Tang, Nantou County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: DenMOS Technology Inc., Hsinchu (TW)

(21) Appl. No.: 11/465,463

(22) Filed: Aug. 18, 2006

(30) Foreign Application Priority Data
May 5, 2006 (TW) 95116007

(51) Int. Cl. G09G 5/00

(52) U.S. Cl. 345/204

(57) ABSTRACT

A driver apparatus for offset cancel and an amplifier apparatus for offset cancel thereof are provided. The amplifier apparatus for offset cancel includes an offset cancellation unit and an amplifier unit. The offset cancellation unit determines the timing and state of an output control signal according to a latch signal and a polarity signal in a panel display device. The amplifier unit is coupled to the offset cancellation unit, so as to switch an input terminal signal and a feedback path of the amplifier unit according to the control signal output by the offset cancellation unit, thereby canceling the offsets of the amplifier apparatus.

### CROSS-REFERENCE TO RELATED APPLICATION

This application claims the priority benefit of Taiwan application serial no. 95116007, filed on May 5, 2006. All disclosure of the Taiwan application is incorporated herein by reference.

### BACKGROUND OF THE INVENTION

1. Field of Invention

The present invention relates to a driver apparatus for driving a display panel, and more particularly to an amplifier apparatus for offset cancel and a driver apparatus using the same.

2. Description of Related Art

Generally, the output stage of a common source driver is formed by a differential amplifier (i.e., in the unit gain buffer type). However, it is appreciated by those skilled in the art that, since the input terminals of the differential amplifier are not accurately matched, a physical phenomenon of offset voltage always occurs, thereby further influencing the image quality presented by the display.

In the conventional art, in order to solve the above problem, a switched capacitor is generally added at the feedback path of the differential amplifier and used to memorize and cancel (in real time) the offset voltage of the differential amplifier. For example, techniques disclosed in US Patent Publication No. U.S. Pat. No. 6,784,865 and No. U.S. Pat. No. 6,586,990 both relate to adding a switched capacitor to cancel the offset voltage of the differential amplifier. Alternatively, a resolution counter is utilized to switch the positive, negative input signals and the feedback path of the differential amplifier in time, thereby canceling (in real time) the offset voltage of the differential amplifier. For example, the technique disclosed in US Patent Publication No. U.S. Pat. No. 6,731,263 utilizes similar method to cancel the offset voltage of the differential amplifier.

However, although a preferred effect can be achieved through the technique of adding a switched capacitor at the feedback path of the differential amplifier to cancel the offset voltage, the switched capacitor occupies a large area on the chip; as the size of the display is increasingly large, the cost is correspondingly increased.

In addition, as for the technique of utilizing the resolution counter to cancel the offset voltage of the differential amplifier, since the resolution counter cannot automatically detect the resolution of the display, the resolution data must be input additionally for the resolution counter to make comparison (it must match the built-in value of the resolution counter), and then, the positive, negative input signals and the feedback path of the differential amplifier are switched, so as to cancel the offset voltage of the differential amplifier. It should be noted that, if the additionally input resolution data does not match the built-in value of the resolution counter, the resolution counter is relatively impractical.

### SUMMARY OF THE INVENTION

An objective of the present invention is to provide an amplifier apparatus for offset cancel, wherein the positive and negative input signals and a feedback path of the output stage differential amplifier of the source driver are switched every N frames (e.g., 2 frames) according to the control signal in the panel display device; and in addition with the effect of persistence of human vision, thus the offset voltage of the differential amplifier can be canceled.

Another objective of the present invention is to provide a driver apparatus for offset cancel, which can be utilized in the driver apparatus of the present invention according to the spirit of the above-mentioned amplifier for offset cancel of the present invention, so as to achieve the same advantage as that of the amplifier for offset cancel.

Based upon the above and other objectives, the present invention provides an amplifier apparatus for offset cancel, which is applicable in a panel display device. The amplifier apparatus comprises an offset cancellation unit and an amplifier unit. The offset cancellation unit determines the timing and state of an output control signal according to a latch signal and a polarity signal in the panel display device. The amplifier unit is coupled to the offset cancellation unit to determine the interior of the amplifier unit to be at a first configuration or a second configuration according to the control signal output by the offset cancellation unit. Both the first and second configurations are the negative feedback systems. When the amplifier unit is at the first configuration, it has a first configuration offset; and when the amplifier unit is at the second configuration, it has a second configuration offset. Wherein, the first and second configuration offsets are opposite in polarity.

From another aspect, the present invention provides a driver apparatus for offset cancel, which is suitable for driving a display panel of a panel display device. The driver apparatus comprises a source drive unit and an amplifier apparatus. The source drive unit is used for latching and converting the received pixel data according to the timing of the latch signal in the panel display device, thereby outputting a first pixel signal and used for determining the polarity of the first pixel signal according to the polarity signal in the panel display device. The amplifier apparatus is coupled between the source drive unit and the display panel, and is used for receiving and buffering the first pixel signal output by the source drive unit and outputting a second pixel signal to the display panel. The amplifier apparatus comprises an offset cancellation unit and an amplifier unit. The offset cancellation unit determines the timing and state of the output control signal according to the latch signal and the polarity signal in the panel display device. The amplifier unit is coupled between the source drive unit and the display panel, and is used for buffering the first pixel signal output by the source drive unit and outputting the second pixel signal to the display panel. The amplifier unit determines the interior of the amplifier unit to be at a first configuration or a second configuration according to the control signal output by the offset cancellation unit. Both the first and second configurations are the negative feedback systems. When the amplifier unit is at the first configuration, it has a first configuration offset; and when the amplifier unit is at the second configuration, it has a second configuration offset. Wherein, the first and second configuration offsets are opposite in polarity.

According to an embodiment of the present invention, the above offset cancellation unit comprises a determining unit and a control signal generating unit. The determining unit is used for outputting a frame signal according to the latch signal and the polarity signal in the panel display device. The control signal generating unit is coupled to the determining unit, and used for generating a control signal to the amplifier unit according to the latch signal in the panel display device and the frame signal output by the determining unit.

According to an embodiment of the present invention, the determining unit determines the logic state of the output frame signal according to the polarity signal in the panel display device. If the previous state and the current state of the polarity signal are different, the frame signal output by the determining unit is Logic 0, whereas if the previous state and the current state of the polarity signal are the same, the frame signal output by the determining unit is Logic 1.

According to an embodiment of the present invention, the determining unit comprises a first flip-flop, a second flip-flop and an exclusive NOR gate. An input terminal of the first flip-flop is used for receiving the polarity signal in the panel display device, and a trigger terminal of the first flip-flop is used for receiving the latch signal in the panel display device. An input terminal of the second flip-flop is coupled to the output terminal of the first flip-flop, and a trigger terminal of the second flip-flop is used for receiving the latch signal in the panel display device. A first input terminal of the exclusive NOR gate is coupled to the output terminal of the first flip-flop, a second input terminal of the exclusive NOR gate is coupled to the output terminal of the second flip-flop, and an output terminal of the exclusive NOR gate outputs the frame signal.

In this embodiment, the control signal generating unit comprises a counter for counting the frame signal output by the determining unit, and thereby outputting the control signal to the amplifier unit.

In another embodiment of the present invention, the offset cancellation unit comprises a first determining unit, a second determining unit and a control signal generating unit. The first determining unit is used to output a first frame signal according to the latch signal and the polarity signal in the panel display device. The second determining unit is coupled to the first determining unit, and used for outputting a second frame signal according to the latch signal in the panel display device and the first frame signal output by the first determining unit. The control signal generating unit is coupled to the second determining unit, and used for generating a control signal to the amplifier unit according to the latch signal in the panel display device and the second frame signal output by the second determining unit.

In another embodiment of the present invention, the offset cancellation unit comprises a type determining unit, a switch, a first determining unit, a second determining unit and a control signal generating unit. The type determining unit is used for determining the driving type for the panel display device according to the latch signal and the polarity signal in the panel display device, and outputting a type signal. A control terminal of the switch is used for receiving the type signal output by the type determining unit, and a first input terminal of the switch is used for receiving the polarity signal in the panel display device, wherein the switch determines to electrically connect the first input terminal or the second input terminal of the switch to the output terminal of the switch according to the type signal output by the type determining unit. The first determining unit is coupled to the switch, and used for outputting a first frame signal to the second input terminal of the switch according to the latch signal and the polarity signal in the panel display device. The second determining unit is coupled to the switch, and used for outputting a second frame signal according to the latch signal in the panel display device and the output signal of the switch. The control signal generating unit is coupled to the second determining unit, and used for outputting a control signal to the amplifier unit according to the latch signal in the panel display device and the second frame signal output by the second determining unit.

In another embodiment of the present invention, the above amplifier unit comprises an amplifier, a first input selector and a second input selector. The amplifier has a positive input terminal, a negative input terminal and an output terminal, wherein the output terminal of the amplifier functions as an output terminal of the amplifier unit. A control terminal of the first input selector determines to electrically connect a first input terminal or a second input terminal of the first input selector to an output terminal of the first input selector according to the control signal output by the offset cancellation unit, wherein the first input terminal of the first input selector is coupled to the output terminal of the amplifier, the second input terminal of the first input selector functions as an input terminal of the amplifier unit, and the output terminal of the first input selector is coupled to the positive input terminal of the amplifier. A control terminal of the second input selector determines to electrically connect a first input terminal or a second input terminal of the second input selector to an output terminal of the second input selector according to the control signal outputted by the offset cancellation unit, wherein the first input terminal of the second input selector functions as an input terminal of the amplifier unit, the second input terminal of the second input selector is coupled to the output terminal of the amplifier, and the output terminal of the second input selector is coupled to the negative input terminal of the amplifier.

In this embodiment, when the amplifier unit is at the first configuration, the second input terminal of the first input selector is electrically connected to the output terminal of the first input selector, and the second input terminal of the second input selector is electrically connected to the output terminal of the second input selector. When the amplifier unit is at the second configuration, the first input terminal of the first input selector is electrically connected to the output terminal of the first input selector, and the first input terminal of the second input selector is electrically connected to the output terminal of the second input selector.

In the amplifier for offset cancel in the present invention, the control signal determined by the latch signal and the polarity signal in the panel display device is employed to switch the positive and negative input signals and a feedback path of the output stage differential amplifier of the source driver every N frames (N is a positive integer, that is, one or more frames), thereby canceling the offset voltage of the differential amplifier efficiently in addition with the effect of persistence of human vision. Moreover, in the driver apparatus for offset cancel of the present invention, the control signal in the panel display device is used for replacing the conventional switched capacitor and the resolution counter, thus solving the problems that the area occupied by the switched capacitor is excessively large and the manufacturing cost is correspondingly increased; furthermore, the driver apparatus in the present invention no longer requires inputting additional resolution data. Therefore, it is applicable in various displays.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a driver apparatus for offset cancel according to a preferred embodiment of the present invention.

FIG. 2 is a block diagram of an offset cancellation unit according to an embodiment of the present invention.

FIG. 3 is a block diagram of a type determining unit according to an embodiment of the present invention.

FIG. 4 is a circuit diagram of a first determining unit according to an embodiment of the present invention.

FIG. 5 is a circuit diagram of an amplifier unit according to an embodiment of the present invention.

FIG. 6 is a block diagram of an offset cancellation unit according to an embodiment of the present invention.

FIG. 7 is a block diagram of an offset cancellation unit according to an embodiment of the present invention.

FIG. 8 is a signal timing diagram of stimulating the displaying technique of 1 Line/Row inversion without blanking through a hardware description language (HDL) verilog according to an embodiment and directed to a display panel with even-numbered scan lines.

FIG. 9 is a signal timing diagram of stimulating the displaying technique of 2 Line/Row inversion without blanking through the hardware description language (HDL) verilog according to an embodiment and directed to a display panel with even-numbered scan lines.

FIG. 10 is a signal timing diagram of stimulating the displaying technique of 1 Line/Row inversion without blanking through the hardware description language (HDL) verilog according to an embodiment and directed to a display panel with odd-numbered scan lines.

FIG. 11 and FIG. 12 are signal timing diagrams of stimulating the displaying technique of 1 Line/Row inversion with blanking through the hardware description language (HDL) verilog according to an embodiment and directed to a display panel with even-numbered scan lines.

FIGS. 13-15 are signal timing diagrams of stimulating the displaying technique of 2 Line/Row inversion without blanking through the hardware description language (HDL) verilog according to an embodiment and directed to a display panel with even-numbered scan lines.

FIGS. 16-19 are signal timing diagrams of stimulating the displaying technique of 2 Line/Row inversion without blanking through the hardware description language (HDL) verilog according to an embodiment and directed to a display panel with odd-numbered scan lines.

FIGS. 20-25 are signal timing diagrams of stimulating the displaying technique of 2 Line/Row inversion with blanking through the hardware description language (HDL) verilog according to an embodiment and directed to a display panel with even-numbered scan lines.

FIG. 26 and FIG. 27 are signal timing diagrams of stimulating the displaying technique of 2 Line/Row inversion with blanking through the hardware description language (HDL) verilog according to an embodiment and directed to a display panel with odd-numbered scan lines.

### DESCRIPTION OF EMBODIMENTS

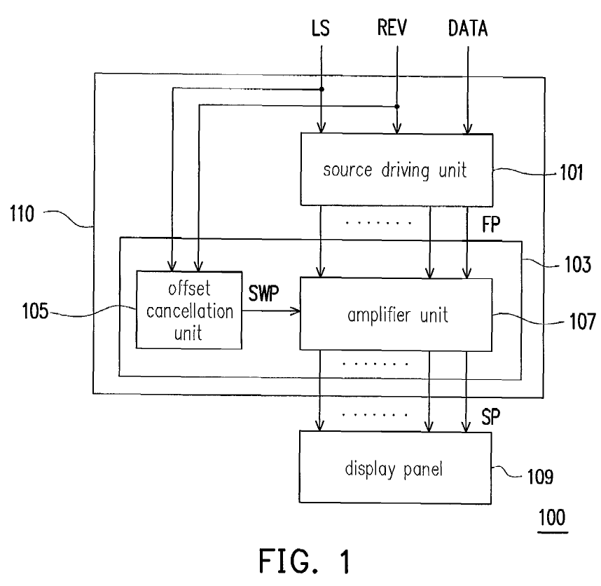

FIG. 1 is a block diagram of a driver apparatus for offset cancel according to a preferred embodiment of the present invention. Referring to FIG. 1, a driver apparatus for offset cancel 100 is suitable for driving a display panel 109 of a panel display device. The driver apparatus for offset cancel 100 utilizes a source driving circuit 110 for offset cancel, so as to cancel the display image with color offsets displayed on the display panel 109, wherein the source driving circuit 110 includes a source drive unit 101 and an amplifier apparatus 103. The source drive unit 101 latches and converts a received pixel data DATA according to the timing of a latch signal LS in the panel display device, outputs a first pixel signal FP, and determines the polarity of the first pixel signal FP output by the source drive unit 101 according to a polarity signal REV in the panel display device. The amplifier apparatus 103 is coupled between the source drive unit 101 and the display panel 109 for receiving and buffering the first pixel signal FP output by the source drive unit 101, and outputting a second pixel signal SP to the display panel.

In this embodiment, the amplifier apparatus 103 includes an offset cancellation unit 105 and an amplifier unit 107. The offset cancellation unit 105 determines the timing and state of an output control signal SWP according to the latch signal LS and the polarity signal REV in the panel display device. The amplifier unit 107 is coupled between the source drive unit 101 and the display panel for buffering the first pixel signal FP output by the source drive unit 101, outputting the second pixel signal SP to the display panel, and for determining the interior of the amplifier unit 107 to be at a first configuration or a second configuration according to the control signal SWP output by the offset cancellation unit 105. Both the first and second configurations are the negative feedback systems. When the amplifier unit is at the first configuration, it has a first configuration offset; when at the second configuration, it has a second configuration offset; and the first and second configuration offsets are opposite in polarity, for example, the first configuration offset is a positive offset, and the second configuration offset is a negative offset.

In this embodiment, the offset cancellation unit 105 may be used for determining the polarity sequence directed to 1 Line/Row inversion and 2 Line/Row inversion in the displaying technique of dot inversion, but the present invention is not limited to this. However, it should be noted that, in all the displaying techniques, the displaying technique of dot inversion achieves the most preferred effect in avoiding flicker noise.

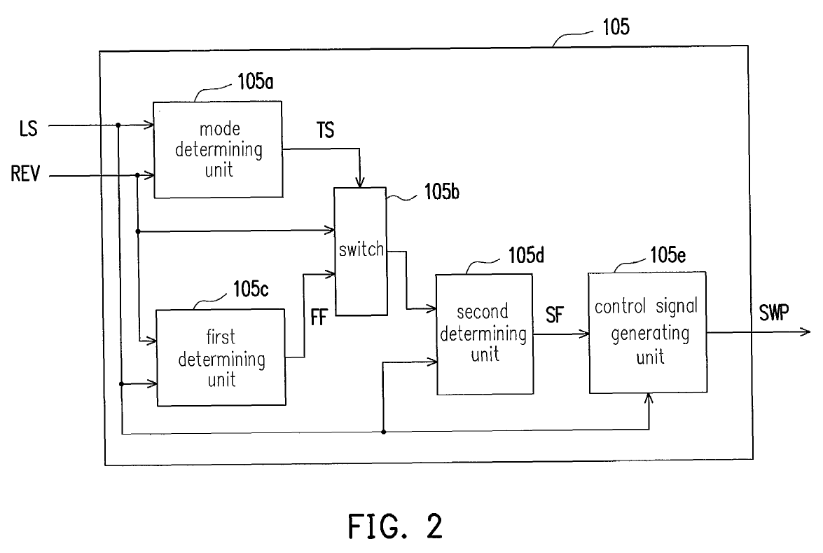

FIG. 2 is a block diagram of the offset cancellation unit 105 according to this embodiment. Referring to FIG. 2, the offset cancellation unit 105 includes a type determining unit 105a, a switch 105b, a first determining unit 105c, a second determining unit 105d and a control signal generating unit 105e. The type determining unit 105a determines a driving type of the panel display device, e.g., a 1 Line/Row inversion or 2 Line/Row inversion, within a time period for scanning one frame according to the latch signal LS and the polarity signal REV in the panel display device, and then outputs a type signal TS. In this embodiment, if the logic state of the type signal TS is Logic 1, the driving type of the panel display device is the 2 Line/Row inversion; and if the logic state of the type signal TS is Logic 0, the driving type of the panel display device is the 1 Line/Row inversion.

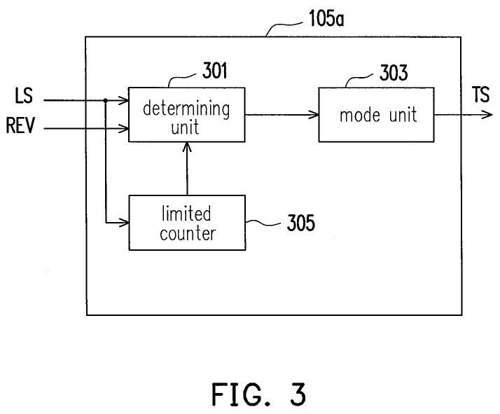

FIG. 3 is a block diagram of the type determining unit 105a in this embodiment. Referring to FIG. 3, the type determining unit 105a includes a determining unit 301, a type unit 303 and a limited counter 305. In this embodiment, when the previous state and the current state of the polarity signal REV in the panel display device are different, the determining unit 301 outputs Logic 0; and when the previous state and the current state of the polarity signal REV are the same, the determining unit 301 outputs Logic 1. The type unit 303 latches the determination results of the determining unit 301, and outputs the type signal TS to the switch 105b. The limited counter 305 is used to restrict that the determining unit 301 must determine the driving type for the panel display device within the time period for scanning the first frame, so as to avoid mistakes in determination. For example, when the determining unit 301 determines that the former and later logic states of the polarity signal REV in the panel display device are different, it outputs a type signal TS with the logic state of 0 via the type unit 303, which indicates that the driving type of the panel display device is the 1 Line/Row inversion. When the determining unit 301 determines that the former and later logic states of the polarity signal in the panel display device are the same, it outputs a type signal TS with the logic state of 1 via the type unit 303, which indicates that the driving type of the panel display device is the 2 Line/Row inversion.

Referring to FIG. 2, the switch 105b determines the signal processing path of the offset cancellation unit 105 according to the type signal TS output by the type determining unit 105a. When the type determining unit 105a determines that the driving type of the panel display device is the 1 Line/Row inversion, the signal processing path of the offset cancellation unit 105, i.e., the latch signal LS and the polarity signal REV, is directly processed via the second determining unit 105d. When the type determining unit 105a determines that the driving type of the panel display device is the 2 Line/Row inversion, the offset cancellation unit 105 makes the latch signal LS and the polarity signal REV be processed for a first time via the first determining unit 105c, and makes the output of the first determining unit 105c and the latch signal LS be processed for a second time via the second determining unit 105d.

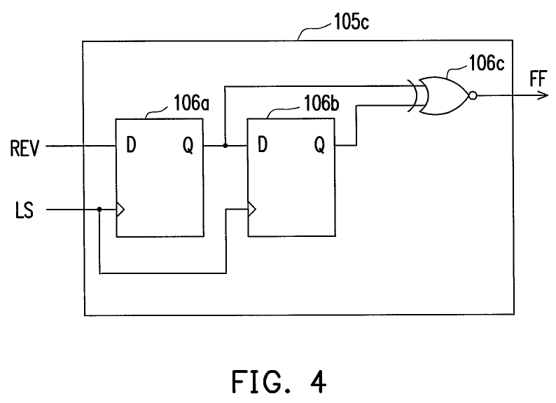

The first determining unit 105c outputs a first frame signal FF according to the latch signal LS and the polarity signal REV. FIG. 4 is a circuit diagram of the first determining unit 105c according to this embodiment. Referring to FIG. 4, the first determining unit 105c includes flip-flops 106a and 106b (e.g., D-type flip-flop herein) and an exclusive NOR gate 106c. An input terminal of the flip-flop 106a is used to receive the polarity signal REV in the panel display device, and a trigger terminal of the flip-flop 106a is used to receive the latch signal LS in the panel display device. An input terminal of the flip-flop 106b is coupled to an output terminal of the flip-flop 106a, and a trigger terminal of the flip-flop 106b is used to receive the latch signal LS in the panel display device. Two input terminals of the exclusive NOR gate 106c are respectively coupled to output terminals of the first flip-flop 106a and the second flip-flop 106b, and an output terminal of the exclusive NOR gate 106c outputs the first frame signal FF.

In this embodiment, if the previous state and the current state of the polarity signal REV in the panel display device are different, the logic state of the first frame signal FF output by the first determining unit 105c is Logic 0. If the previous state and the current state of the polarity signal REV in the panel display device are the same, the logic state of the first frame signal FF output by the first determining unit 105c is Logic 1.

Referring to FIG. 2, when the logic state of the type signal TS output by the determining unit 301 is 1, the second determining unit 105d outputs the second frame signal SF according to logic states of the latch signal LS and the first frame signal FF output by the first determining unit 105c. The circuit structure of the second determining unit 105d may be similar to that of the first determining unit 105c, which of the details will not be described herein any more. In this embodiment, if the second determining unit 105d receives the first frame signal FF output by the first determining unit 105c via the switch 105b, when the previous state and the current state of the first frame signal FF output by the first determining unit 105c are different, the logic state of the second frame signal SF output by the second determining unit 105c is Logic 0. When the previous state and the current state of the first frame signal FF output by the first determining unit 105c are the same, the logic state of the second frame signal SF output by the second determining unit 105c is Logic 1.

The control signal generating unit 105e outputs the control signal SWP to the amplifier unit 107 according to the logic states of the latch signal LS in the panel display device and the second frame signal SF output by the second determining unit 105d. In this embodiment, the control signal generating unit 105e includes a counter for counting the second frame signal SF and thereby outputting the control signal SWP to the amplifier unit 107.

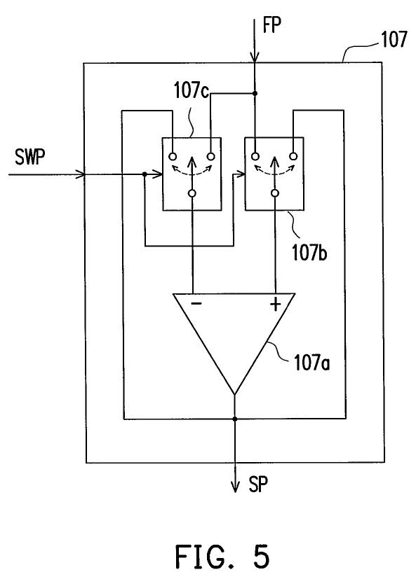

The amplifier unit 107 in FIG. 1 has many channels, and the implementation method of one of the channels is described below as an example. Those skilled in the art may deduce the other implementation methods under the teaching of this embodiment. FIG. 5 is a circuit diagram of the amplifier unit 107 according to this embodiment. Referring to FIG. 5, the amplifier unit 107 includes an amplifier 107a, a first input selector 107b and a second input selector 107c. The amplifier 107a has positive, negative input terminals and an output terminal, and the output terminal of the amplifier 107a functions as an output terminal of the amplifier unit 107. The first input selector 107b and the second input selector 107c respectively has a first input terminal, a second input terminal, a control terminal and an output terminal. The second input terminal of the first input selector 107b and the first input terminal of the second input selector 107c function as the input terminals of the amplifier unit 107 for receiving the first pixel signal FP output by the source drive unit 101. The control terminals of the first input selector 107b and the second input selector 107c are used to receive the control signal SWP output by the offset cancellation unit 105. The output terminals of the first input selector 107b and the second input selector 107c are respectively coupled to the positive, negative input terminals of the amplifier 107a, and the first input terminal of the first input selector 107b and the second input terminal of the second input selector 107c are coupled to the output terminal of the amplifier 107a.

According to the timing and state of the control signal SWP output by the offset cancellation unit 105, the interior of the amplifier unit 107 is determined to be at a first configuration or a second configuration. Both the first and second configurations are the negative feedback systems. When the interior of the amplifier unit 107 is at the first configuration, the second input terminal of the first input selector 107b and the second input terminal of the second input selector 107c are electrically connected to the output terminals of the first input selector 107b and the second input selector 107c, and form a unit gain amplifier having a first configuration offset together with the amplifier 107a. When the interior of the amplifier unit 107 is at the second configuration, the first input terminal of the first input selector 107b and the first input terminal of the second input selector 107c are electrically connected to the output terminals of the first input selector 107b and the second input selector 107c, and form a unit gain amplifier having a second configuration offset together with the amplifier 107a, wherein the first and second configuration offsets are opposite in polarity.

In this embodiment, according to the timing and state of the control signal SWP output by the offset cancellation unit 105, a unit gain amplifier with two configurations (i.e., unit gain amplifier having positive, negative offsets) is formed in the amplifier unit 107, thus each of four frames is defined as a cycle for canceling offsets. In addition, in this embodiment, since the 1 Line/Row inversion and the 2 Line/Row inversion of the displaying technique of dot inversion are utilized, it is known that in the above-mentioned each of four frames, the sequence of the polarity signal REV in the first and third frames are the same, and the sequence of the polarity signal REV in the second and fourth frames are the same. According to the internal configuration of the amplifier 107 in this embodiment, it is known that, the internal configuration of the amplifier unit 107 may be alternated by changing the state of the control signal SWP every 2 frames, thereby effectively canceling the offsets of the amplifier apparatus 103.

However, the present invention is not limited to changing the state of the control signal SWP every 2 frames to correspondingly alternate the internal configuration of the amplifier unit 107 and thereby canceling the offsets of the amplifier unit 107. According to the spirits of the present invention, the present invention is also applicable in the displaying technique of non-dot inversion, such that the state of the control signal SWP is changed every 1 frame or N frames, so as to control the internal configuration of the amplifier 107, and thereby also canceling the offsets of the amplifier unit 107.

It should be noted that, in this embodiment, since the internal configuration of the amplifier unit 107 is alternated every 2 frames, it is known that the control signal generating unit 105e must make the frequency of the second frame signal SF output by the second determining unit 105d be divided by 2, and thereby outputting the control signal SWP accordingly. In addition, if the second determining unit 105d does not output the second frame signal SF, the control signal unit 105e automatically outputs the control signal SWP according to the determination results of the type determining unit 105a.

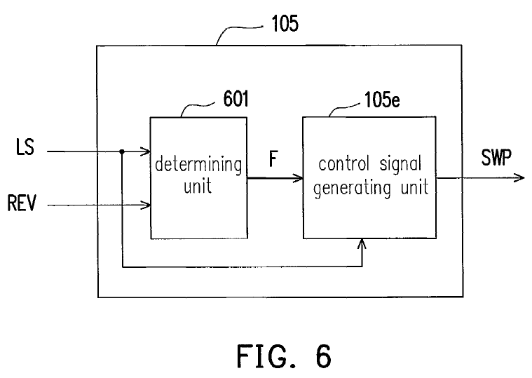

FIG. 6 is a block diagram of an offset cancellation unit 105 according to another embodiment of the present invention. Referring to FIG. 1, FIG. 2 and FIG. 6, the offset cancellation unit 105 in FIG. 6 includes a determining unit 601 and a control signal generating unit 105e. The operating method of the determining unit 601 is similar to that of the first determining unit 105c in FIG. 2, thus the details will not be described herein. The determining unit 601 outputs a frame signal F according to the latch signal LS and the polarity signal REV in the panel display device. The control signal generating unit 105e outputs the control signal SWP for controlling the amplifier unit 107 according to the latch signal LS in the panel display device and the frame signal F output by the determining unit 601. In this embodiment, the offset cancellation unit 105 in FIG. 6 is applicable in the 1 Line/Row inversion of the displaying technique of dot inversion.

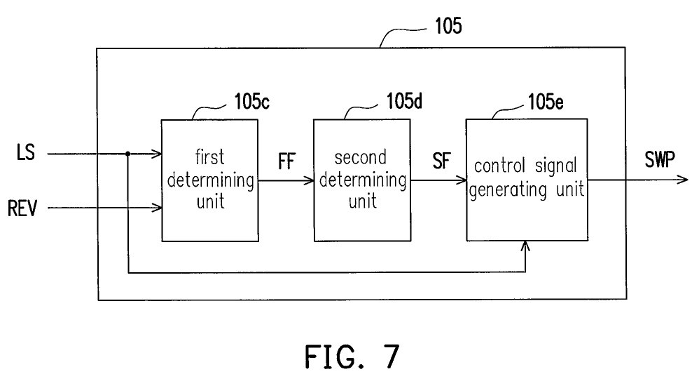

FIG. 7 is a block diagram of an offset cancellation unit 105 according to another embodiment of the present invention. Referring to FIG. 1, FIG. 2 and FIG. 7 together, the offset cancellation unit 105 in FIG. 7 includes a first determining unit 105c, a second determining unit 105d and a control signal generating unit 105e. According to the description of the above embodiment, circuit structures, coupling relationships and functions of the first determining unit 105c, the second determining unit 105d and the control signal generating unit 105e will not be described herein any more. In this embodiment, the offset cancellation unit 105 in FIG. 7 is applicable in the 2 Line/Row inversion in the displaying technique of dot inversion.

In another embodiment of the present invention, the offset cancellation unit 105 in FIG. 2, FIG. 6 and FIG. 7 may further include a multiplexer (not shown) that is used for selecting one of a signal in the offset cancellation unit 105 (i.e., a frame signal F, a first frame signal FF, or a second frame signal SF) or an external frame signal FRAME to send to the control signal generating unit 105e according to the state of a select line CAN. The control signal generating unit 105e outputs the control signal SWP according to the signal output by the multiplexer.

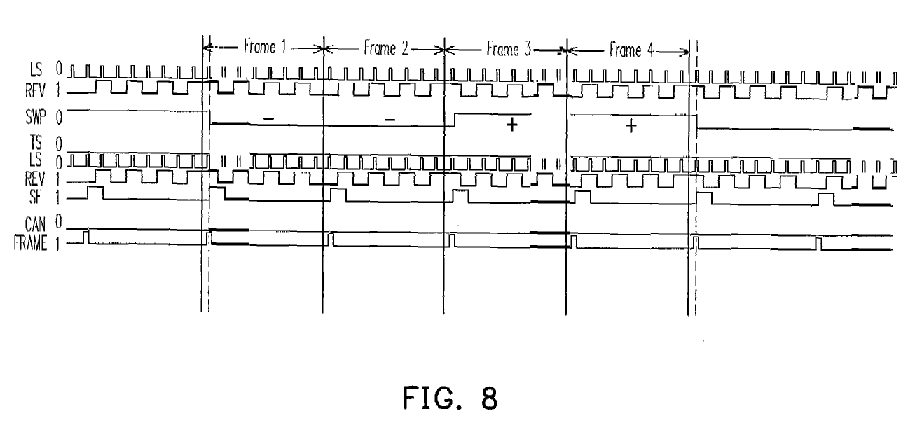

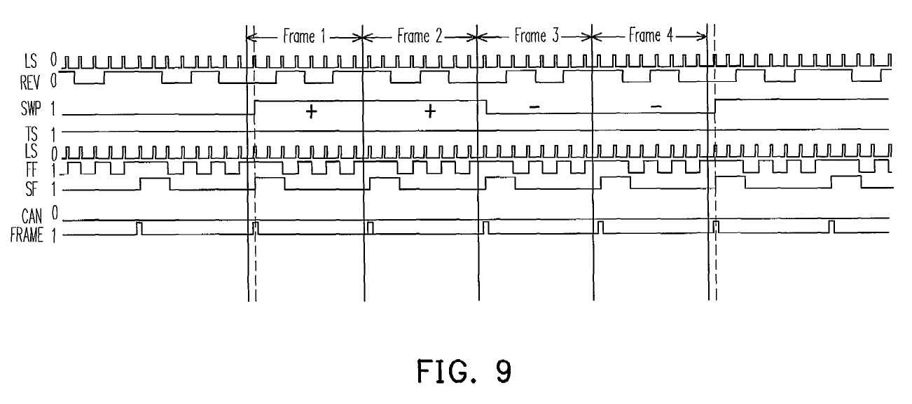

As described in the above embodiment, the offset cancellation unit 105 of the amplifier apparatus 103 determines the timing and state of the control signal SWP according to the latch signal LS and the polarity signal REV in the panel display device. FIG. 8 is a signal timing diagram of stimulating the displaying technique of 1 Line/Row inversion without blanking through a hardware description language (HDL) verilog according to this embodiment and directed to a display panel with even-numbered scan lines. FIG. 9 is a signal timing diagram of stimulating the displaying technique of 2 Line/Row inversion without blanking through the hardware description language (HDL) verilog according to this embodiment and directed to a display panel with even-numbered scan lines. Referring to FIG. 2, FIG. 8 and FIG. 9 together, the logic state of the select line CAN in FIG. 8 and FIG. 9 is Logic 0, such that the control signal generating unit 105e utilizes the signal in the offset cancellation unit 105. Otherwise, if the logic state of the select line CAN is Logic 1, the control signal generating unit 105e utilizes the external frame signal FRAME.

As know from FIG. 8 and FIG. 9, no matter in the displaying technique of 1 Line/Row inversion or 2 Line/Row inversion, the timing and state of the control signal SWP are changed every 2 frames. Therefore, the internal configuration of the amplifier unit 107 is alternated every 2 frames (i.e., switching positive and negative input signals and a feedback path of the amplifier 107) according to the timing and state of the control signal SWP output by the offset cancellation unit 105; in addition with the effect of persistence of human vision, the offsets of the amplifier apparatus 103 can be effectively cancelled.

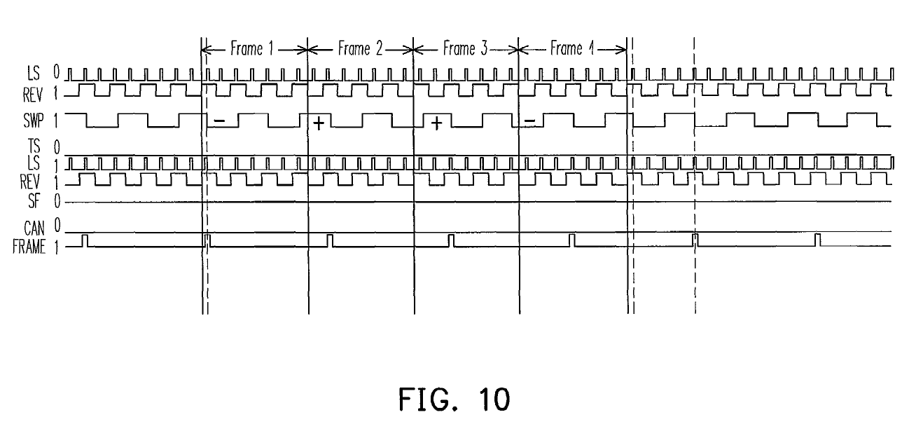

FIG. 10 is a signal timing diagram of stimulating the displaying technique of 1 Line/Row inversion without blanking through the hardware description language (HDL) verilog according to this embodiment and directed to a display panel with odd-numbered scan lines.

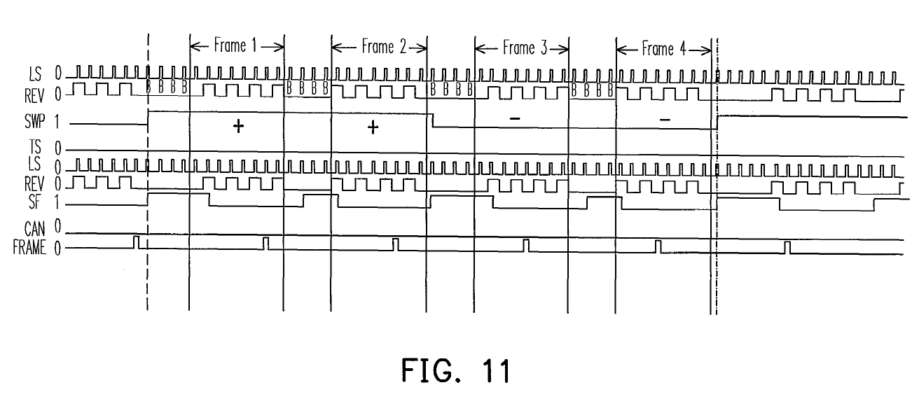

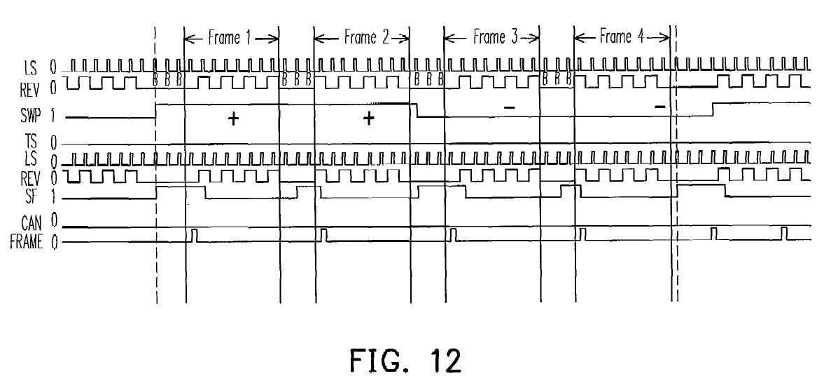

FIG. 11 and FIG. 12 are signal timing diagrams of stimulating the displaying technique of 1 Line/Row inversion with blanking through the hardware description language (HDL) verilog according to this embodiment and directed to a display panel with even-numbered scan lines.

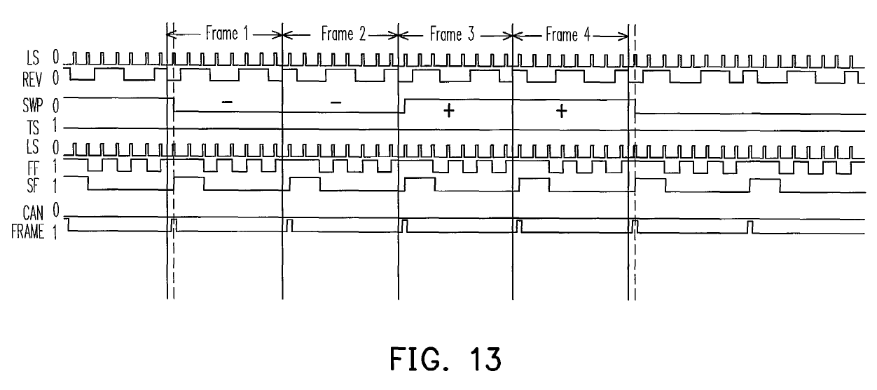

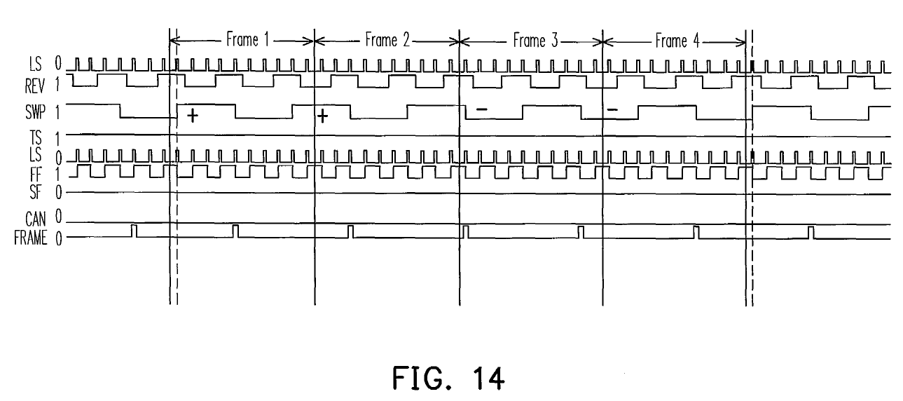

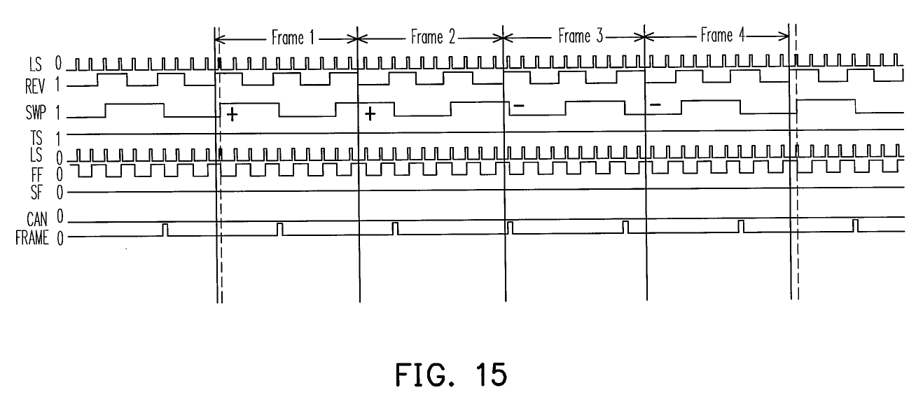

FIGS. 13-15 are signal timing diagrams of stimulating the displaying technique of 2 Line/Row inversion without blanking through the hardware description language (HDL) verilog according to this embodiment and directed to a display panel with even-numbered scan lines.

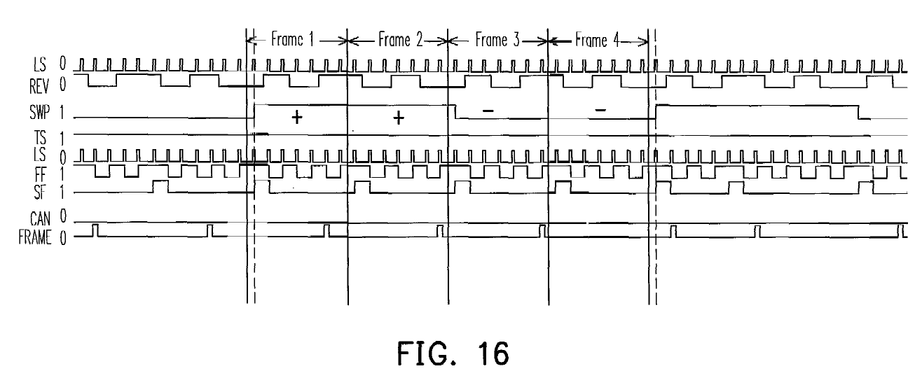

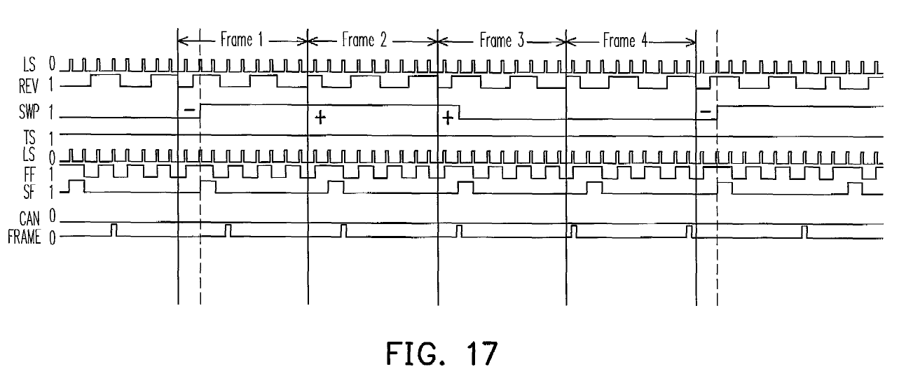

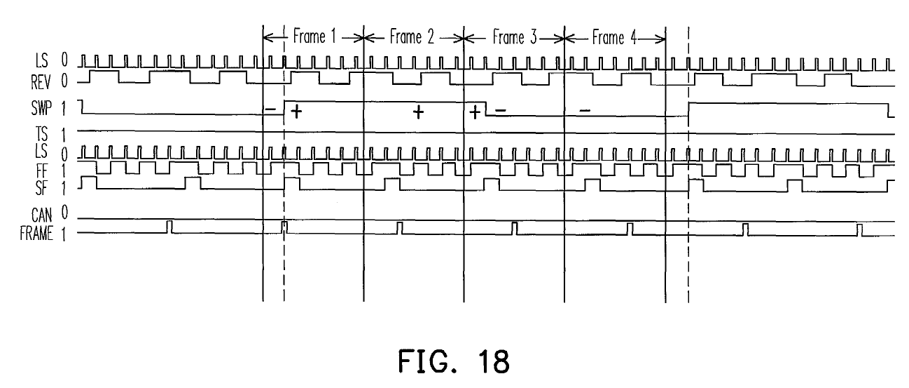

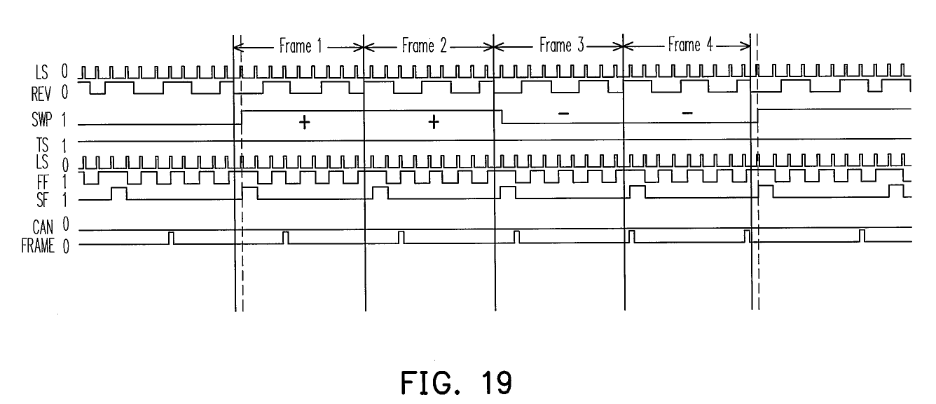

FIGS. 16-19 are signal timing diagrams of stimulating the displaying technique of 2 Line/Row inversion without blanking through the hardware description language (HDL) verilog according to this embodiment and directed to a display panel with odd-numbered scan lines.

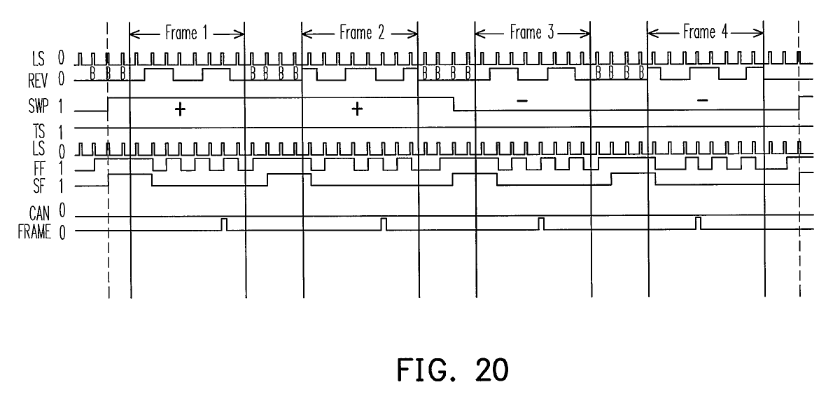

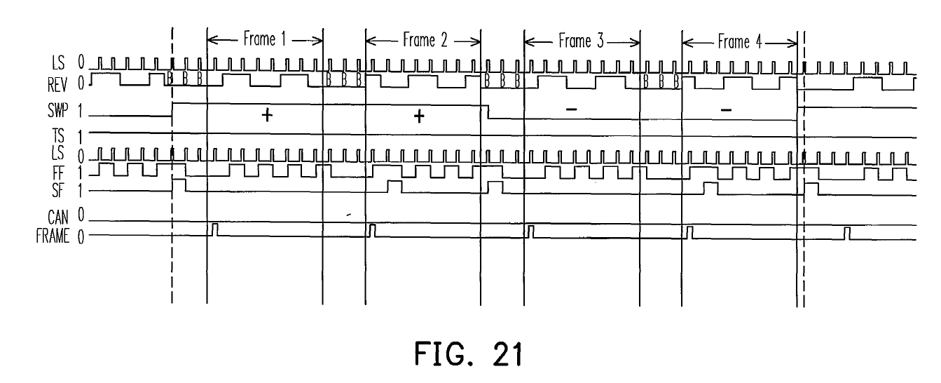

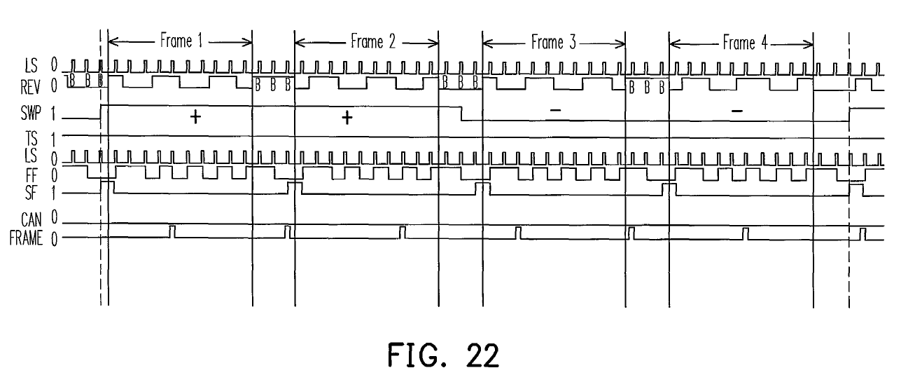

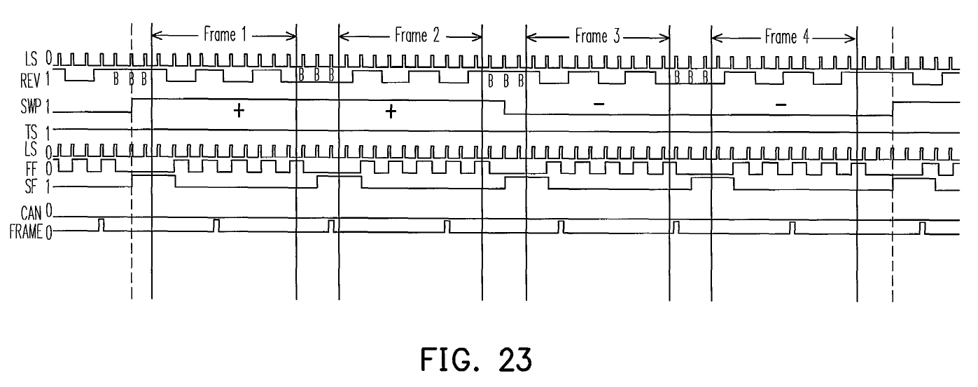

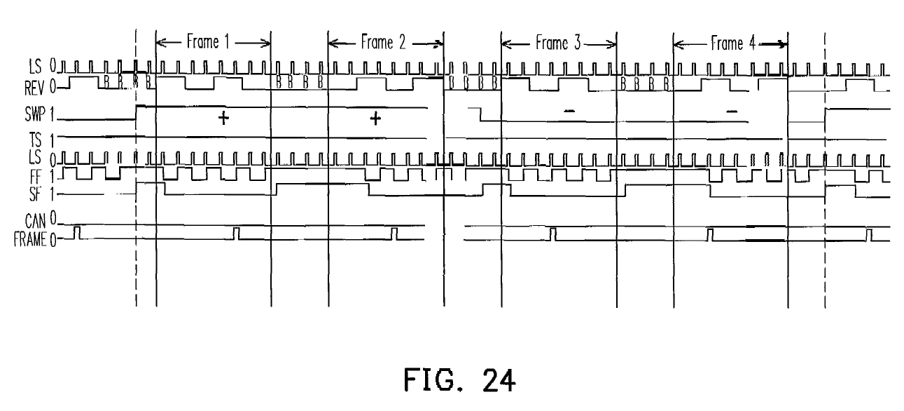

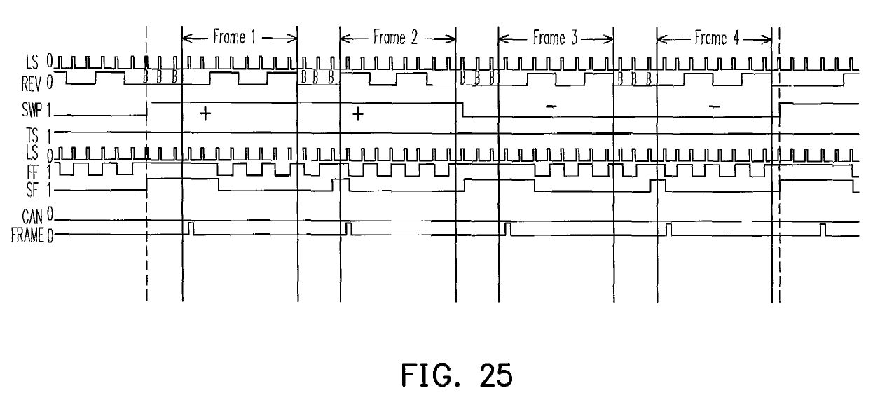

FIGS. 20-25 are signal timing diagrams of stimulating the displaying technique of 2 Line/Row inversion with blanking through the hardware description language (HDL) verilog according to this embodiment and directed to a display panel with even-numbered scan lines.

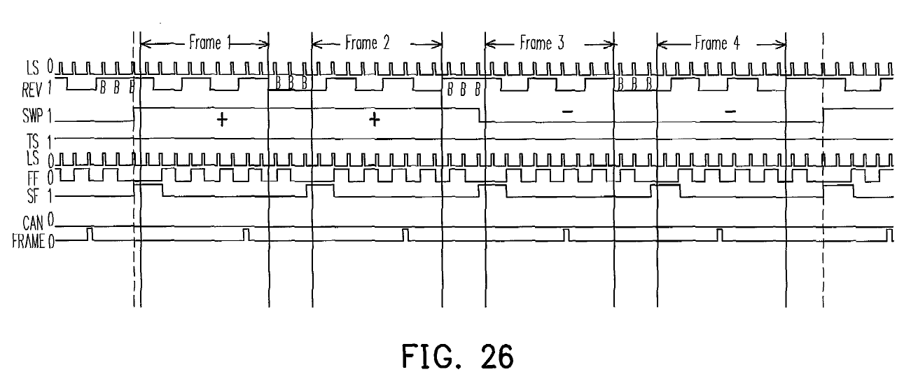

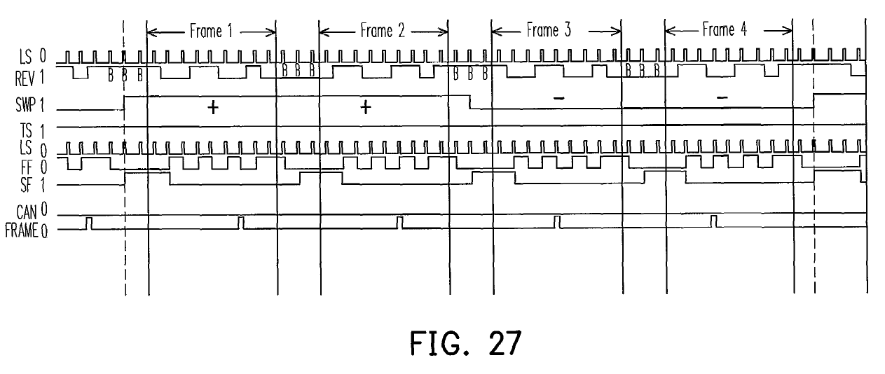

FIG. 26 and FIG. 27 are signal timing diagrams of stimulating the displaying technique of 2 Line/Row inversion with blanking through the hardware description language (HDL) verilog according to this embodiment and directed to a display panel with odd-numbered scan lines.

The above FIGS. 10-27 are signal timing diagrams of stimulating the displaying technique of single and 2 Line/Row inversion through the hardware description language (HDL) verilog according to a preferred embodiment of the present invention. Regardless whether there are odd numbered or even numbered scan lines in each frame or there is a blanking B between each frame, it is evident that the present invention can be used to cancel the offset voltage of the differential amplifier correctly and effectively.

In summary, when the amplifier for offset cancel provided in the present invention is applied to the driver apparatus, it has the following advantages according to the spirits of the present invention.

1. The conventional switched capacitor is replaced, such that the problem that the switched capacitor occupies an excessively large area on the chip is solved and thereby reducing the manufacturing cost.

2. The conventional resolution counter is replaced, and no resolution data is required to be input additionally, thus it is applicable in various displays, and is relatively practical.

It will be apparent to those skilled in the art that various modifications and variations can be made to the structure of the present invention without departing from the scope or spirit of the invention. In view of the foregoing, it is intended that the present invention cover modifications and variations of this invention provided they fall in the scope of the following claims and their equivalents.

What is claimed is:

1. An amplifier apparatus for offset cancel, applicable in a panel display device, comprising:
an offset cancellation unit, for outputting a control signal and determining the timing and state of the control signal according to a latch signal and a polarity signal in the panel display device; and
an amplifier unit, coupled to the offset cancellation unit and used for determining the interior of the amplifier unit to be one of a first configuration and a second configuration according to the control signal, both the first and second configurations are the negative feedback systems, wherein when the amplifier unit is at the first configuration, the amplifier unit has a first configuration offset, when the amplifier unit is at the second configuration, the amplifier unit has a second configuration offset, and the first and second configuration offsets are opposite in polarity.

2. The amplifier apparatus for offset cancel as claimed in claim 1, wherein the offset cancellation unit comprises:
a determining unit, for outputting a frame signal according to the latch signal and the polarity signal in the panel display device; and
a control signal generating unit, coupled to the determining unit and used for outputting the control signal to the amplifier unit according to the latch signal in the panel display device and the frame signal.

3. The amplifier apparatus for offset cancel as claimed in claim 2, wherein when the previous state and the current state of the polarity signal are different, the frame signal output by the determining unit is Logic 0; when the previous state and the current state of the polarity signal are the same, the frame signal output by the determining unit is Logic 1.

4. The amplifier apparatus for offset cancel as claimed in claim 2, wherein the determining unit comprises:
a first flip-flop, having an input terminal receiving the polarity signal, and a trigger terminal receiving the latch signal;
a second flip-flop, having an input terminal coupled to an output terminal of the first flip-flop, and a trigger terminal receiving the latch signal; and
an exclusive NOR gate, having a first input terminal coupled to the output terminal of the first flip-flop, a second input terminal coupled to an output terminal of the second flip-flop, and an output terminal outputting the frame signal.

5. The amplifier apparatus for offset cancel as claimed in claim 2, wherein the control signal generating unit comprises a counter used for counting the frame signal and thereby outputting the control signal to the amplifier unit.

6. The amplifier apparatus for offset cancel as claimed in claim 1, wherein the offset cancellation unit comprises:
a first determining unit, for outputting a first frame signal according to the latch signal and the polarity signal in the panel display device;
a second determining unit, coupled to the first determining unit and used for outputting a second frame signal according to the latch signal in the panel display device and the first frame signal output by the first determining unit; and
a control signal generating unit, coupled to the second determining unit and used for outputting the control signal to the amplifier unit according to the latch signal in the panel display device and the second frame signal.

7. The amplifier apparatus for offset cancel as claimed in claim 1, wherein the offset cancellation unit comprises:
a type determining unit, for determining a driving type of the panel display device according to the latch signal and the polarity signal to output a type signal;
a switch, having a control terminal coupled to an output of the type determining unit, a first input terminal receiving the polarity signal, wherein the switch determines to electrically connect one of the first input terminal and the second input terminal of the switch to an output terminal thereof according to the type signal;
a first determining unit, coupled to the switch and used for outputting the first frame signal to the second input terminal of the switch according to the latch signal and the polarity signal in the panel display device;
a second determining unit, coupled to the switch and used for outputting the second frame signal according to the latch signal in the panel display device and the output of the switch; and
a control signal generating unit, coupled to the second determining unit and used for outputting the control signal to the amplifier unit according to the latch signal in the panel display device and the second frame signal.

8. The amplifier apparatus for offset cancel as claimed in claim 1, wherein the amplifier unit comprises:
an amplifier, comprising a positive input terminal, a negative input terminal and an output terminal, wherein the output terminal of the amplifier functions as an output terminal of the amplifier unit;
a first input selector, for determining to electrically connect one of a first input terminal and a second input terminal of the first input selector to an output terminal thereof according to a signal at a control terminal thereof, wherein the control terminal of the first input selector receives the control signal, the first input terminal of the first input selector is coupled to the output terminal of the amplifier, the second input terminal of the first input selector functions as an input terminal of the amplifier unit, and the output terminal of the first input selector is coupled to the positive input terminal of the amplifier; and
a second input selector, for determining to electrically connect one of a first input terminal and a second input terminal of the second input selector to an output terminal thereof according to a signal at a control terminal thereof, wherein the control terminal of the second input selector receives the control signal, the first input terminal of the second input selector functions as an input terminal of the amplifier unit, the second input terminal of the second input selector is coupled to the output terminal of the amplifier, and the output terminal of the second input selector is coupled to the negative input terminal of the amplifier.

9. The amplifier apparatus for offset cancel as claimed in claim 8, wherein when the amplifier unit is at the first configuration, the first input selector electrically connects the second input terminal thereof to the output terminal thereof, and the second input selector electrically connects the second input terminal thereof to the output terminal thereof; when the amplifier unit is at the second configuration, the first input selector electrically connects the first input terminal thereof to the output terminal thereof, and the second input selector electrically connects the first input terminal thereof to the output terminal thereof.

10. The amplifier apparatus for offset cancel as claimed in claim 8, wherein the amplifier is a unit gain amplifier.

11. A driver apparatus for offset cancel, used for driving a display panel of a panel display device, the driver apparatus comprising:
a source drive unit, for latching and converting a pixel data according to a timing of a latch signal, outputting a first pixel signal and further determining the polarity of the first pixel signal according to a polarity signal; and
an amplifier apparatus, coupled between the source drive unit and the display panel, and used for receiving and buffering the first pixel signal, so as to output a second pixel signal to the display panel, wherein the amplifier apparatus comprises:
an offset cancellation unit, for outputting a control signal and determining the timing and state of the control signal according to the latch signal and the polarity signal in the panel display device; and
an amplifier unit, coupled between the source drive unit and the display panel and coupled to the offset cancellation unit, and used for buffering the first pixel signal and outputting the second pixel signal to the display panel, wherein the amplifier unit determines the interior of the amplifier unit to be one of a first configuration and a second configuration according to the control signal, both the first and second configurations are the negative feedback systems; when the amplifier unit is at the first configuration, the amplifier unit has a first configuration offset; when the amplifier unit is at the second configuration, the amplifier unit has a second configuration offset; and the first and second configuration offsets are opposite in polarity.

12. The driver apparatus for offset cancel as claimed in claim 11, wherein the offset cancellation unit comprises:
a determining unit, for outputting a frame signal according to the latch signal and the polarity signal in the panel display device; and
a control signal generating unit, coupled to the determining unit and used for outputting the control signal to the amplifier unit according to the latch signal in the panel display device and the frame signal.

13. The driver apparatus for offset cancel as claimed in claim 12, wherein when the previous state and the current state of the polarity signal are different, the frame signal output by the determining unit is Logic 0; when the previous state and the current state of the polarity signal are the same, the frame signal output by the determining unit is Logic 1.

14. The driver apparatus for offset cancel as claimed in claim 12, wherein the determining unit comprises:
a first flip-flop, having an input terminal receiving the polarity signal, and a trigger terminal receiving the latch signal;
a second flip-flop, having an input terminal coupled to an output terminal of the first flip-flop, and a trigger terminal receiving the latch signal; and
an exclusive NOR gate, having a first input terminal coupled to the output terminal of the first flip-flop, a second input terminal coupled to an output terminal of the second flip-flop, and an output terminal outputting the frame signal.

15. The driver apparatus for offset cancel as claimed in claim 12, wherein the control signal generating unit comprises a counter used for counting the frame signal and thereby outputting the control signal to the amplifier unit.

16. The driver apparatus for offset cancel as claimed in claim 11, wherein the offset cancellation unit comprises:
a first determining unit, for outputting a first frame signal according to the latch signal and the polarity signal in the panel display device;
a second determining unit, coupled to the first determining unit and used for outputting a second frame signal according to the latch signal in the panel display device and the first frame signal output by the first determining unit; and
a control signal generating unit, coupled to the second determining unit and used for outputting the control signal to the amplifier unit according to the latch signal in the panel display device and the second frame signal.

17. The driver apparatus for offset cancel as claimed in claim 11, wherein the offset cancellation unit comprises:
a type determining unit, for determining a driving type of the panel display device according to the latch signal and the polarity signal, so as to output a type signal;
a switch, having a control terminal coupled to an output of the type determining unit, and a first input terminal receiving the polarity signal, wherein the switch determines to electrically connect one of a first input terminal and a second input terminal of the switch to an output terminal thereof according to the type signal;
a first determining unit, coupled to the switch and used for outputting a first frame signal to the second input terminal of the switch according to the latch signal and the polarity signal in the panel display device;
a second determining unit, coupled to the switch and used for outputting a second frame signal according to the latch signal in the panel display device and the output of the switch; and
a control signal generating unit, coupled to the second determining unit and used for outputting the control signal to the amplifier unit according to the latch signal in the panel display device and the second frame signal.

18. The driver apparatus for offset cancel as claimed in claim 11, wherein the amplifier unit comprises:
an amplifier, comprising a positive input terminal, a negative input terminal and an output terminal, wherein the output terminal of the amplifier functions as an output terminal of the amplifier unit;
a first input selector, for determining to electrically connect one of a first input terminal and a second input terminal of the first input selector to an output terminal thereof according to a signal at a control terminal thereof, wherein the control terminal of the first input selector receives the control signal, the first input terminal of the first input selector is coupled to the output terminal of the amplifier, the second input terminal of the first input selector functions as an input terminal of the amplifier unit, and the output terminal of the first input selector is coupled to the positive input terminal of the amplifier; and
a second input selector, for determining to electrically connect one of a first input terminal and a second input terminal of the second input selector to an output terminal thereof according to a signal at a control terminal thereof, wherein the control terminal of the second input selector receives the control signal, the first input terminal of the second input selector functions as an input terminal of the amplifier unit, the second input terminal of the second input selector is coupled to the output terminal of the amplifier, and the output terminal of the second input selector is coupled to the negative input terminal of the amplifier.

19. The driver apparatus for offset cancel as claimed in claim 18, wherein when the amplifier unit is at the first configuration, the first input selector electrically connects the second input terminal thereof to the output terminal thereof, and the second input selector electrically connects the second input terminal thereof to the output terminal thereof; when the amplifier unit is at the second configuration, the first input selector electrically connects the first input terminal thereof to the output terminal thereof, and the second input selector electrically connects the first input terminal thereof to the output terminal thereof.

20. The driver apparatus for offset cancel as claimed in claim 18, wherein the amplifier is a unit gain amplifier.
